(19) United States
(12) Patent Application Publication
(10) Pub. No.: US 2025/0206246 A1
(43) Pub. Date: Jun. 26, 2025

(54) COIL SPRING CARTRIDGE

(71) Applicant: KOSTAL Automobil Elektrik GmbH & Co. KG, Luedenscheid (DE)

(72) Inventors: Raphael KLEINE, Bochum (DE); Guido PASCHMANN, Dortmund (DE)

(73) Assignee: KOSTAL Automobil Elektrik GmbH & Co. KG, Luedenscheid (DE)

(21) Appl. No.: 19/079,027

(22) Filed: Mar. 13, 2025

Related U.S. Application Data
(63) Continuation of application No. PCT/EP2024/062187, filed on May 3, 2024.

(30) Foreign Application Priority Data
May 8, 2023 (DE) 102023111916.8

(51) Int. Cl. B60R 16/027; H02G 11/02

(52) U.S. Cl. CPC B60R 16/027; H02G 11/02

(57) ABSTRACT

A coil spring cartridge includes a cylindrical stator housing part and a rotor housing part, three flexible flat cables each having at least one electrical conductor, and a flexible flat ribbon lacking an electrical conductor. The flat cables and the flat ribbon with their respective ends are fastened on the one hand to the stator housing part and on the other hand to the rotor housing part, and are wound so tightly on the respective housing parts that a U-shaped reversal section that reverses the winding direction is formed between their ends. The flexible flat cables and the flat ribbon, when contacting each of the lateral faces of the winding gap, cooperate in their sequence of superposition and in their respective internal configuration to form a desired waveguide geometry.

### CROSS-REFERENCE TO RELATED APPLICATIONS

This application is a continuation of International Application No. PCT/EP2024/062187, published in German, with an international filing date of May 3, 2024, which claims priority to DE 10 2023 111 916.8, filed May 8, 2023, the disclosures of which are hereby incorporated in their entirety by reference herein.

### TECHNICAL FIELD

The present invention relates to a coil spring cartridge including a stationary cylindrical stator housing part (“stator”), a rotatable cylindrical rotor housing part (“rotor”) that is rotatable about its longitudinal axis and is situated coaxially with respect to the stator, a winding gap that is delimited by the outer lateral face of the stator (the interior housing part) and the inner lateral face of the rotor (the exterior housing part), at least one flexible flat cable having at least one electrical conductor, and at least one flexible flat ribbon that is used to mechanically stabilize the flat cable, the flat cable and the flat ribbon being situated in a way such that their respective first ends are fastened to the stator and their respective second ends are fastened to the rotor and such that the flat cable and the flat ribbon are wound with a respective first section of their length resting against the outer lateral face of the stator and with a respective second section of their length resting against the inner lateral face of the rotor in the opposite direction so that a U-shaped reversal section that reverses the winding direction in each case is formed between the respective two sections of the flat cable and of the flat ribbon.

### BACKGROUND

These types of coil spring cartridges are provided, for example, to allow energy and/or data to be reliably transferred in motor vehicles between connecting points that are rotatably mounted in the steering wheel and stationarily situated in the steering column. For example, an airbag system, a steering wheel heating system, a switching device, etc., may be supplied with voltages and signals, necessary for them to function, via the connecting points of such a device.

Such a coil spring cartridge is known from EP 0 556 779 B1, in which multiple flexible flat cables are accommodated inside an annular cavity of a housing. One end of each flat cable is fixed to the stator, and the other end of each flat cable is fixed to the rotor that is rotatable with respect to the stator. The flat cables are each windable with their two wide sides over a U-shaped reversal section in each case, having at least one winding on the axially oriented inner wall of the rotor and spaced apart therefrom, and when reversed, having at least one further winding on the axially oriented outer wall of the stator and spaced apart therefrom.

When a plurality of flat cables is required for providing the necessary electrical connections, this plurality of flat cables is situated in such a way that their respective end sections on the outer lateral face of the interior stator housing part and on the inner lateral face of the exterior rotor housing part overlap, and the U-shaped reversal sections of each of the flat cables generate an elastic pressure force that brings about secure contact of the inwardly or outwardly wound areas of the other flat cables against the housing lateral faces.

When the number of flat cables required for providing the necessary electrical connections is smaller than that necessary for ensuring proper mechanical functioning of the coil spring cartridge, so-called “dummy cables” are used instead of further flat cables. Dummy cables are clastic flat ribbons that have the same mechanical properties as the flat cables, but unlike the flat cables, the dummy cables have no electrical strip conductors. A dummy cable is thus less costly than a flat cable. Standard plastic bands made of PET, for example, are used as dummy cables. In practical application, use of at least four cables or dummy cables has proven advantageous to ensure proper mechanical functioning of the coil spring cartridge. Particularly, for only a small number of electrical potentials to be transferred, it is thus possible to achieve significant cost savings by using dummy cables, for example, by utilizing only one flat cable and three flat ribbons as dummy cables.

Due to the increasing scope of electronic functions in a steering wheel, there is a need for rapid and interference-free data transfer via a coil spring cartridge. However, this is possible only to a limited extent due to the line geometries of flat cables presently used. Rapid data transfer requires a line system whose impedance is adapted to the impedance of the supply lines used. Particularly for transfer of fast signals, i.e., having data rates up to 100 M bits/s, for example on a so-called automotive Ethernet, it is desirable to adapt the line impedance of the coil spring to the line impedance of a twisted line that is typically used, which is generally approximately 100 ohms. In addition, the impedance should be influenced as little as possible by rotation of the coil spring cartridge.

To meet these electrical requirements, with known standard values for spacings and material thicknesses it would be necessary for a flat cable to have a thickness greater than 435 μm. However, a flat cable with such a thickness would not meet the mechanical demands with regards to flexibility. Namely, for use in a coil spring cartridge, the flat cable must be extremely flexible and thus as thin as possible, and should have a load capacity of six million bending cycles for a radius of eight mm.

### SUMMARY

An object of the present invention is a coil spring cartridge having the advantage, over the background art, of providing a line system that is suitable for rapid data transfer and that has an adapted impedance, and whose flat cables meet the high mechanical demands.

This object is achieved according to the present invention in that the coil spring cartridge includes at least three flexible flat cables and three flat ribbons, the flat cables and the flat ribbons when contacting each of the lateral faces of the winding gap arranged between the stator and the rotor of the coil spring cartridge, cooperate in their sequence of superposition and in their respective internal configuration to form a desired waveguide geometry.

In carrying out the above and/or other objects, a coil spring cartridge is provided. The coil spring cartridge includes a stator, a rotor rotatable relative to the stator, a winding gap between the stator and the rotor, first, second, and third flexible flat cables each having at least one electrical conductor, and a flexible flat ribbon lacking an electrical conductor. The flat cables and the flat ribbon are arranged in the winding gap in such a way that respective first ends of the flat cables and of the flat ribbon are fastened to the stator and respective second ends of the flat cables and of the flat ribbon are fastened to the rotor and that the flat cables and the flat ribbon are wound with a respective first section of a length of the flat cables and of the flat ribbon resting against the stator and with a respective second section of a length of the flat cables and of the flat ribbon resting against the rotor in opposite directions so that a U-shaped reversal section that reverses a winding direction in each case is formed between the respective first and second sections of the flat cables and of the flat ribbon.

The flat cables and the flat ribbon may be layered in a sequence of superposition comprised of the first flat cable, the flat ribbon, the second flat cable, and the third flat cable. The coil spring cartridge may further include a second flexible flat ribbon lacking an electrical conductor, the second flat ribbon arranged in the winding gap and layered in the sequence of superposition following the third flat cable such that the third flat cable is between the second flat cable and the second flat ribbon. The coil spring cartridge may further include a third flexible flat ribbon lacking an electrical conductor, the third flat ribbon arranged in the winding gap and layered in the sequence of superposition following the second flat ribbon such that the second flat ribbon is between the third flat cable and the second flat ribbon.

The first flat cable may have a plurality of electrical conductors. The second flat cable may have only one electrical conductor. The third flat cable may have only one electrical conductor. The electrical conductor of the second flat cable may be at ground potential and the electrical conductor of the third flat cable may be at a supply voltage potential.

The electrical conductors of the first flat cable may include a pair of electrical conductors as data lines and a pair of electrical conductors at ground potential, and the pair of electrical conductors as data lines situated directly next to one another and enclosed by the pair of electrical conductors at ground potential.

In one preferred embodiment, it is provided in the sequence of the at least three flexible flat cables and three flat ribbons that the first flat cable has at least four electrical conductors and a thin metallic coating on its surface facing the second flat cable, the second flat cable has an electrical conductor at ground potential, the third flat cable has an electrical conductor for transferring the supply voltage, the first flat ribbon without electrical conductors is situated between the first and second flat cables, and the second and third flat ribbons without electrical conductors are situated next to the third flat cable.

### BRIEF DESCRIPTION OF THE DRAWINGS

Further advantageous embodiments of the subject matter of the present invention are set forth herein, and are explained in greater detail based on one exemplary embodiment illustrated in the drawings, which show the following:

FIG. 1 illustrates a cross section of a layering of flexible flat cables and flexible flat ribbons in a coil spring cartridge according to an embodiment of the present invention; and

FIG. 2 illustrates a cross-sectional view of an embodiment of a conventional coil spring cartridge.

### DETAILED DESCRIPTION

Detailed embodiments of the present invention are disclosed herein; however, it is to be understood that the disclosed embodiments are merely exemplary of the present invention that may be embodied in various and alternative forms. The figures are not necessarily to scale; some features may be exaggerated or minimized to show details of components. Therefore, specific structural and functional details disclosed herein are not to be interpreted as limiting, but merely as a representative basis for teaching one skilled in the art to variously employ the present invention.

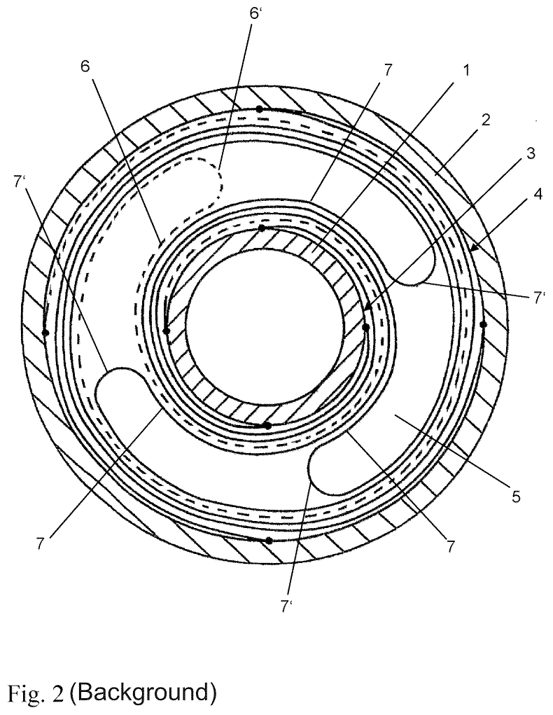

Referring initially to FIG. 2, a cross-sectional view of an embodiment of a conventional coil spring cartridge is shown. The coil spring cartridge includes the above-mentioned minimum number of four cables or dummy cables. The coil spring cartridge is shown in FIG. 2 for explaining the general operating principle of a coil spring cartridge in accordance with embodiments of the present invention.

As shown in FIG. 2, the coil spring cartridge (or clock spring cartridge, coil spring cassette, clock spring cassette) includes a housing having a stationary (i.e., fixed) cylindrical stator housing part (“stator”) 1 and a rotatable cylindrical rotor housing part (“rotor”) 2. Rotor 2 is rotatable about its longitudinal axis and is situated coaxially with respect to stator 1. The housing of the coil spring cartridge further includes an annular cavity that forms a winding gap 5. Winding gap 5 is delimited by an outer lateral face 3 of stator 1 and an inner lateral face of rotor 2. Stator 1 is an “interior” housing part and rotor 2 is an “exterior” housing part as the stator is surrounded by the rotor with winding gap 5 therebetween. Rotor 2 is rotatable about the interior stator 1 situated coaxially with respect to the rotor.

A coil spring cartridge including the above-mentioned minimum number of four cables or dummy cables includes at least four cables consisting of flexible flat cables and/or flexible flat ribbons. The at least four cables are accommodated within a winding gap inside an annular cavity of the housing of the coil spring cartridge. As indicated, a flat cable includes at least one electrical conductor whereas a flat ribbon has the same mechanical properties as a flat cable but has no electrical conductor. As such, a flat cable and a flat ribbon are cables with the flat cable being an electrical cable whereas the flat ribbon is not an electrical cable. As further indicated, a flat ribbon is also referred to as a dummy cable or an elastic ribbon.

As indicated, the coil spring cartridge shown in FIG. 2 is a coil spring cartridge that includes the above-mentioned minimum number of four cables or dummy cables. The minimum number of four cables or dummy cables of the coil spring cartridge shown in FIG. 2 consists of a flexible flat cable 6 and three flat ribbons 7. Flat cable 6 is illustrated by a dashed line in FIG. 2. Flat ribbons 7 are illustrated by solid lines in FIG. 2.

Flat cable 6 is accommodated in winding gap 5 of the housing of the coil spring cartridge. As indicated, winding gap 6 is formed between outer lateral face 3 of stator 1 and inner lateral face 4 of rotor 2. Flat cable 6 is fastened at its first end to stator 1 and at its second end to rotor 2. Flat cable 6 is thus situated in winding gap 5 in such a way that with a section of its length adjoining at its first end the flat cable is wound resting against outer lateral face 3 of stator 1, and with a section of its length adjoining at its second end the flat cable is wound in the opposite direction resting against inner lateral face 4 of rotor 2. Situated between these two sections of flat cable 6 is a U-shaped reversal section 6′. U-shaped reversal section 6′ reverses the winding direction of the two sections. When rotor 2 rotates in one direction or the other, U-shaped reversal section 6′ moves along the circumference of winding gap 5, and flat cable 6 is wound at its one side and unwound at its other side.

The three flat ribbons 7 are accommodated in winding gap 5 of the housing of the coil spring cartridge. Flat ribbons 7 are accommodated in winding gap 5 to mechanically stabilize flat cable 6 and, particularly, to ensure the firm contact of the end sections of flat cable 6 against lateral faces 3 and 4. Flat ribbons 7 are accommodated in winding gap 5 in the same way as flat cable 6. Particularly, flat ribbons 7 are accommodated in winding gap 5 in such a way that the four U-shaped reversal sections 6′ and 7′ of flat cable 6 and flat ribbons 7 are arranged at the same angular interval of approximately 90° relative to one another.

In principle, a coil spring cartridge designed according to embodiments of the present invention has the same construction as the coil spring cartridge shown in FIG. 2. In this regard, as described with the coil spring cartridge shown in FIG. 2, a coil spring cartridge in accordance with embodiments of the present invention includes stator 1, rotor 2, winding gap 5 delimited by outer lateral face 3 of stator 1 and inner lateral face 4 of rotor 2, and the minimum number of four cables or dummy cables accommodated within the winding gap.

However, a coil spring cartridge in accordance with embodiments of the present invention differs from the coil spring cartridge shown in FIG. 2 by the inner designs of flat cables and by a certain arrangement of flat cables and flat ribbons relative to one another. A coil spring cartridge in accordance with embodiments of the present invention may further differ from the coil spring cartridge shown in FIG. 2 by the number of flat cables and flat ribbons. In embodiments of the present invention, the number of flat cables and flat ribbons total at least six in number.

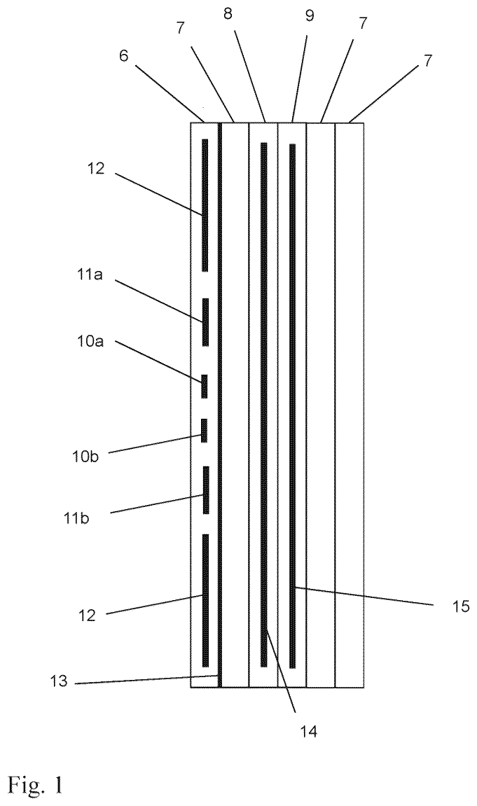

Referring now to FIG. 1, with continual reference to FIG. 2, a cross section of a layering of flat cables and flat ribbons in a coil spring cartridge according to an embodiment of the present invention is shown. In this embodiment, the number of flat cables and flat ribbons total six in number.

Particularly, as shown in FIG. 1, the coil spring cartridge according to this embodiment includes three flat cables 6, 8, and 9 and three flat ribbons 7. The layering of flat cables 6, 8, and 9 and the three flat ribbons 7 shown in FIG. 1 results when the flat cables and the flat ribbons rest against one of lateral faces 3 and 4 of winding gap 5. The sequence of superposed flat cables 6, 8, and 9 and flat ribbons 7 and their respective internal configuration result in the desired waveguide geometry.

With reference to FIG. 1, the sequence of superposed flat cables 6, 8, and 9 and flat ribbons 7, and respective internal configurations of flat cables 6, 8, and 9 and flat ribbons 7 will now be described in greater detail. As shown in FIG. 1, the layering of flat cables and flat ribbons from left-to-right in FIG. 1 is first flat cable 6, first flat ribbon 7, second flat cable 8, third flat cable 9, second flat ribbon 7, and third flat ribbon 7.

As further shown in FIG. 1, first flat cable 6, the actual data cable, has multiple electrical conductors 10a, 10b, 11a, 11b, 12. First flat cable 6 further has a thin metallic coating, the so-called coupling surface 13, on its surface facing second flat cable 8. Coupling surface 13 may be applied to first flat cable 6 using a thin film PVD process, for example. Second flat cable 8 has only one electrical conductor 14. Electrical conductor 14 is at ground potential and extends practically over the entire width of second flat cable 8. First flat ribbon 7, being a dummy cable, is situated between first and second flat cables 6 and 8. First flat ribbon 7 provides a certain spacing between electrical conductors 10a, 10b, 11a, 11b, 12 of first flat cable 6 and electrical conductor 14 of second flat cable 8, which is at ground potential. Third flat cable 9, like second flat cable 8, has only one electrical conductor 15. Electrical conductor 15 is connected to a supply voltage (not shown) via which a supply voltage of generally +12 volts is transferred. Electrical conductor 15 extends practically over the entire width of third flat cable 9. Third flat cable 9 is situated, without spacers, directly next to second flat cable 8. Second flat ribbon 7 and third flat ribbon 7 are situated next to third flat cable 9. Second and third flat ribbons 7 are used to ensure a sufficient distance between third flat cable 9 and first flat cable 6, which, depending on the present rotational position of the coil spring cartridge upon multiple revolutions, once again comes to rest there.

The internal configuration of first flat cable 6 includes electrical conductors 10a, 10b, 11a, 11b, 12. Electrical conductors 10a, 10b, 11a, 11b, 12 are all situated approximately centrally in first flat cable 6 along the thickness of first flat cable 6 and are all enclosed by a sheath made of an insulation material. The actual data lines are made up of two conductors 10a, 10b situated in parallel to one another, each having a width of 0.2 mm and a spacing of 0.6 mm from one another. A pair of electrical conductors 11a, 11b at ground potential is situated externally adjoining this pair of data lines 10a, 10b. Optional further electrical conductors 12 may in turn be situated externally adjoining this pair of ground lines 11a, 11b.

While exemplary embodiments are described above, it is not intended that these embodiments describe all possible forms of the present invention. Rather, the words used in the specification are words of description rather than limitation, and it is understood that various changes may be made without departing from the spirit and scope of the present invention. Additionally, the features of various implementing embodiments may be combined to form further embodiments of the present invention.

What is claimed is:

1. A coil spring cartridge comprising:
a stator;
a rotor rotatable relative to the stator;
a winding gap between the stator and the rotor;
first, second, and third flexible flat cables each having at least one electrical conductor;
a flexible flat ribbon lacking an electrical conductor; and
the flat cables and the flat ribbon being arranged in the winding gap in such a way that respective first ends of the flat cables and of the flat ribbon are fastened to the stator and respective second ends of the flat cables and of the flat ribbon are fastened to the rotor and that the flat cables and the flat ribbon are wound with a respective first section of a length of the flat cables and of the flat ribbon resting against the stator and with a respective second section of a length of the flat cables and of the flat ribbon resting against the rotor in opposite directions so that a U-shaped reversal section that reverses a winding direction in each case is formed between the respective first and second sections of the flat cables and of the flat ribbon.

2. The coil spring cartridge of claim 1 wherein:
the flat cables and the flat ribbon are layered in a sequence of superposition comprised of the first flat cable, the flat ribbon, the second flat cable, and the third flat cable.

3. The coil spring cartridge of claim 2 further comprising:
a second flexible flat ribbon lacking an electrical conductor, the second flat ribbon arranged in the winding gap and layered in the sequence of superposition following the third flat cable such that the third flat cable is between the second flat cable and the second flat ribbon.

4. The coil spring cartridge of claim 3 further comprising:
a third flexible flat ribbon lacking an electrical conductor, the third flat ribbon arranged in the winding gap and layered in the sequence of superposition following the second flat ribbon such that the second flat ribbon is between the third flat cable and the second flat ribbon.

5. The coil spring cartridge of claim 2 wherein:
the first flat cable has a plurality of electrical conductors;
the second flat cable has only one electrical conductor; and
the third flat cable has only one electrical conductor.

6. The coil spring cartridge of claim 5 wherein:
the electrical conductor of the second flat cable is at ground potential; and
the electrical conductor of the third flat cable is at a supply voltage potential.

7. The coil spring cartridge according to claim 6 wherein:
the electrical conductors of the second and third flat cables extend over an entire width of the second and third flat cables.

8. The coil spring cartridge of claim 5 wherein:
the first flat cable further has a metallic coating on a surface facing the second flat cable.

9. The coil spring cartridge of claim 5 wherein:
the electrical conductors of the first flat cable are situated centrally in the first flat cable along a thickness of the first flat cable, the electrical conductors of the first flat cable including a pair of electrical conductors as data lines and a pair of electrical conductors at ground potential, and the pair of electrical conductors as data lines situated directly next to one another and enclosed by the pair of electrical conductors at ground potential.

10. The coil spring cartridge according claim 9 wherein:
the electrical conductors of the first flat cable further include another pair of electrical conductors, the other pair of electrical conductors situated externally adjoining the pair of electrical conductors at ground potential.

11. The coil spring cartridge according to claim 9 wherein:
the electrical conductors of the first flat cable each have a width of 0.2 mm and a spacing of 0.6 mm from one another.

12. A coil spring cartridge comprising:
a stationary cylindrical stator housing part; and
a cylindrical rotor housing part that is rotatable about its longitudinal axis and situated coaxially with respect to the stationary cylindrical stator housing part, wherein a winding gap that is delimited by an outer lateral face of the stator housing part and an inner lateral face of the rotor housing part is formed in which at least one flexible flat cable having at least one electrical conductor and at least one flexible flat ribbon used to mechanically stabilize the flat cable are situated in such a way that their respective first ends are fastened to the stator housing part and their respective second ends are fastened to the rotor housing part, and are wound with a respective first section of their length resting against the outer lateral face of the stator housing part, and with a respective second section of their length resting against the inner lateral face of the rotor housing part in the opposite direction, so that a U-shaped reversal section that reverses the winding direction in each case is formed between the respective two sections of the flat cable and of the flat ribbon, wherein in that at least three flexible flat cables and three flat ribbons, when contacting each of the lateral faces of the winding gap, cooperate in their sequence of superposition and in their respective internal configuration to form a desired waveguide geometry.

13. The coil spring cartridge according to claim 12 wherein:
the flat cable that is first in the sequence has at least four electrical conductors and on its surface facing the second flat cable has a thin metallic coating, the second flat cable has an electrical conductor at ground potential, the third flat cable has an electrical conductor for transferring a supply voltage, and one of the flat ribbons is situated between the first and second flat cables and the other two flat ribbons are situated next to the third flat cable.

14. The coil spring cartridge according to claim 13 wherein:
the electrical conductors of the first flat cable are situated centrally along a thickness of the first flat cable, and a pair of electrical conductors as data lines situated directly next to one another are enclosed by a pair of electrical conductors at ground potential.

15. The coil spring cartridge according to claim 14 wherein:
the electrical conductors of the first flat cable each have a width of 0.2 mm and a spacing of 0.6 mm from one another.

16. The coil spring cartridge according to claim 13 wherein:
the electrical conductors of the second and third flat cables respectively extend over an entire width of the second and third flat cables.

17. The coil spring cartridge according claim 14 wherein:
further electrical conductors of the first flat cable are situated externally adjoining the pair of electrical conductors of the first flat cable at ground potential.
